(19) United States
(12) Patent Application Publication
(10) Pub. No.: US 2025/0191354 A1
(43) Pub. Date: Jun. 12, 2025

(54) PRE-TRAINING APPARATUS, METHOD, AND STORAGE MEDIUM

(71) Applicant: KABUSHIKI KAISHA TOSHIBA, Tokyo (JP)

(72) Inventors: Tenta SASAYA, Urayasu Chiba (JP); Takashi IDA, Kawasaki Kanagawa (JP); Toshiyuki ONO, Kawasaki Kanagawa (JP)

(73) Assignee: KABUSHIKI KAISHA TOSHIBA, Tokyo (JP)

(21) Appl. No.: 18/802,193

(22) Filed: Aug. 13, 2024

(30) Foreign Application Priority Data
Dec. 6, 2023 (JP) 2023-206304

(51) Int. Cl. G06V 10/82; G06V 10/75; G06V 10/77

(52) U.S. Cl. CPC G06V 10/82; G06V 10/751; G06V 10/7715

(57) ABSTRACT

A pre-training apparatus includes processing circuitry. The processing circuitry is configured to: convert an input image to generate a conversion image; generate a first extended image and a second extended image from the conversion image based on a method different from a method for generating the conversion image; input the first extended image to a first feature extractor to calculate a first feature amount; input the second extended image to a second feature extractor to calculate a second feature amount; and update a parameter of at least one of the first feature extractor and the second feature extractor based on the first feature amount and the second feature amount.

### CROSS-REFERENCE TO RELATED APPLICATIONS

This application is based upon and claims the benefit of priority from Japanese Patent Application No. 2023-206304, filed Dec. 6, 2023, the entire contents of which are incorporated herein by reference.

### FIELD

Embodiments described herein relate generally to a pre-training apparatus, a method, and a storage medium.

### BACKGROUND

Effectiveness of a neural network that executes an image-target task for image identification and the like has been confirmed. In the initial introduction phase or the initial examination phase of such a neural network, only a small number of labeled data may be available as training data, considering the training cost. As an effective method in this case, a method is known in which pre-training is performed by unsupervised training using a large amount of unlabeled data and then retraining (fine tuning) using a small amount of labeled data is performed. However, depending on the type of task, a large amount of data cannot be collected due to a cause such as a measurement cost, or unlabeled data cannot be used for pre-training in some cases.

In addition, there has been a method of training a general-purpose model using an artificial image generated based on a random number by using a property of training focusing on a local structure of an image. However, since a suitable artificial image differs depending on the type of the task, a general-purpose pre-training method that can be used regardless of the type of the task is required.

### BRIEF DESCRIPTION OF THE DRAWINGS

FIG. 1 is a diagram illustrating an example of a configuration of a pre-training apparatus according to a first embodiment.

FIG. 2 is a flowchart illustrating a processing procedure of pre-training processing according to the first embodiment.

FIG. 3 is a diagram illustrating a flow of data in pre-training processing according to the first embodiment.

FIG. 4 is a diagram for explaining processing of converting input images according to the first embodiment.

FIG. 5 is a diagram for explaining processing related to representation learning according to the first embodiment.

FIG. 6 is a diagram illustrating an example of a configuration of a pre-training apparatus according to a second embodiment.

FIG. 7 is a flowchart illustrating a processing procedure of pre-training processing according to the second embodiment.

FIG. 8 is a diagram illustrating a flow of data in pre-training processing according to the second embodiment.

FIG. 9 is a flowchart illustrating a processing procedure of pre-training processing according to a modification of the second embodiment.

### DETAILED DESCRIPTION

In general, according to one embodiment, a pre-training apparatus includes processing circuitry. The processing circuitry is configured to: convert an input image to generate a conversion image; generate a first extended image and a second extended image from the conversion image based on a method different from a method for generating the conversion image; input the first extended image to a first feature extractor to calculate a first feature amount; input the second extended image to a second feature extractor to calculate a second feature amount; and update a parameter of at least one of the first feature extractor and the second feature extractor based on the first feature amount and the second feature amount.

Hereinafter, embodiments of a pre-training apparatus, a pre-training method, and a storage medium will be described in detail with reference to the drawings. In the following description, components having substantially the same functions and configurations are denoted by the same reference numerals, and redundant description will be made only if necessary.

### First Embodiment

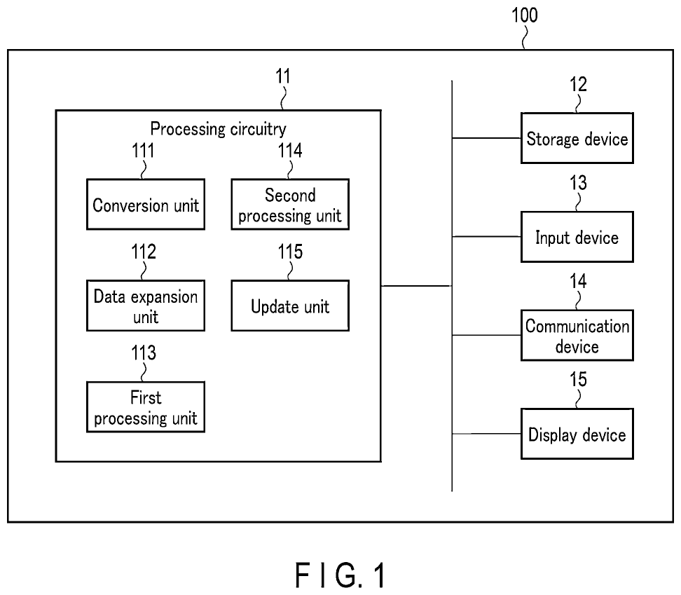

FIG. 1 is a diagram illustrating an example of a configuration of a pre-training apparatus 100 according to a first embodiment. The pre-training apparatus 100 is a training device that trains a neural network based on labeled training data. The neural network is a machine learning model that receives an input of image data and outputs a feature vector of the image data. The pre-training apparatus 100 is connected to a database or the like in which training data is recorded via a network or the like. As the training data, for example, multi-dimensional image data is used. Hereinafter, the image data is simply referred to as an image. In addition, an image input to the neural network is referred to as an input image.

The pre-training apparatus 100 trains a neural network including a feature extractor by optimizing the feature extractor by representation learning using the feature extractor. As the representation learning, for example, an arbitrary contrastive learning method can be used.

The trained neural network is used for various image-target tasks such as image identification, object detection in an image, image segmentation, and abnormality detection.

The pre-training apparatus 100 is a computer including processing circuitry 11, a storage device 12, an input device 13, a communication device 14, and a display device 15. Data communication among the processing circuitry 11, the storage device 12, the input device 13, the communication device 14, and the display device 15 is performed via a bus. The input device 13 and the display device 15 may not be provided.

The processing circuitry 11 includes a processor such as a central processing unit (CPU) and a memory such as a random access memory (RAN). The processing circuitry 11 includes a conversion unit 111, a data expansion unit 112, a first processing unit 113, a second processing unit 114, and an update unit 115. The processing circuitry 11 realizes a conversion function, a data extension function, a first processing function, a second processing function, and an update function by each of the above-described units by executing a pre-training program.

The storage device 12 includes a read only memory (ROM), a hard disk drive (HDD), a solid state drive (SSD), an integrated circuit storage device, and the like. The storage device 12 stores the pre-training program and the like.

The pre-training program is stored in a non-transitory computer-readable recording medium such as the storage device 12. The pre-training program may be implemented as a single program that describes all the functions of the above units, or may be implemented as a plurality of modules divided into several functional units. Each of the above units may be implemented by an integrated circuit such as an application specific integrated circuit (ASIC). In such a case, the units may be implemented on a single integrated circuit, or separately on different integrated circuits.

The input device 13 inputs various commands from an operator. As the input device 13, a keyboard, a mouse, various switches, a touch pad, a touch panel display, and the like can be used. An output signal from the input device 13 is supplied to the processing circuitry 11.

The communication device 14 is an interface for performing data communication with an external device connected to the pre-training apparatus 100 via a network. For example, the communication device 14 performs data communication with a database that stores an input image used as labeled training data.

The display device 15 displays various types of information. As the display device 15, a cathode-ray tube (CRT) display, a liquid crystal display, an organic electro luminescence (EL) display, a light-emitting diode (LED) display, a plasma display, or any other display known in the art can be appropriately used. Furthermore, the display device 15 may be a projector.

Next, functions executed by each unit of the processing circuitry 11 will be described in detail.

The conversion unit 111 converts the input image to generate a conversion image. At this time, the conversion unit 111 generates a conversion image in which the local structure of the input image is maintained and the global structure of the input image is deformed. The local structure is, for example, an element related to a feature of a target subject such as a pixel value, a color, or a shape of an element included in an image. An image having a changed local structure may not be appropriate as training data depending on the type of task. On the other hand, an image whose local structure has not changed can be used as training data regardless of the type of task. The global structure is an element related to position information and arrangement of pixels. Even if the global structure changes, it can be used as training data regardless of the type of task. As the conversion method, for example, a method of perturbing and replacing a partial image, a method using affine transformation, a method of rearranging partial images, and the like can be used. Another conversion method may be used as long as the conversion method deforms the global structure while maintaining the local structure of the input image. The conversion unit 111 may be referred to as a duplication unit that duplicates the input image.

As a method of perturbing and replacing a partial image, for example, a method using GPNN or SinGAN can be used. In this case, the conversion unit 111 generates a plurality of adjusted images obtained by converting the resolution of an input image, generates a partial image obtained by clipping the same portion from each adjusted image, and generates a perturbation partial image obtained by adding perturbation to each partial image. Thereafter, the plurality of perturbation partial images is combined by weighting and adding the perturbation partial images having different resolutions. Then, a portion in the original input image corresponding to the perturbation partial image is replaced with the combined perturbation partial image to generate a conversion image. As a result, it is possible to generate the conversion image in which the local structure of the original input image is maintained and the global structure of the original input image is deformed.

The affine transformation includes, for example, geometric transformation and rotation. In the method using the affine transformation, a plurality of conversion images is generated by applying the affine transformation to the input image. A plurality of conversion images may be generated from an input image by executing a plurality of affine transformations using random numbers.

In the method of rearranging partial images, an input image is divided into a plurality of partial images, and the plurality of divided images is rearranged and combined to generate a conversion image. Then, by changing the arrangement of the partial images, a plurality of conversion images can be generated from an input image. In addition, the number of conversion images to be generated may be increased by performing horizontal inversion, vertical inversion, or rotation processing on one or more partial images and then rearranging the partial images.

In addition, the conversion image may be generated from the input image using a pre-trained model based on the target image or an image similar to the target image. For example, as described in Non-Patent Literature 3, in the case of a GAN that performs image conversion based on one or more trained parameters, it is also possible to generate a conversion image by calculating an input vector for generating an input image by a generator and then inputting, to the generator, the input vector on which noise is superimposed.

Note that a plurality of conversion images may be generated from an input image by changing a parameter in a method among the above methods, or a plurality of conversion images may be generated from an input image by combining a plurality of methods among the above methods.

The data expansion unit 112, the first processing unit 113, the second processing unit 114, and the update unit 115 performs training of a neural network using representation learning. As the representation learning, for example, contrastive learning can be used. Hereinafter, a case will be described, as an example, in which contrastive learning using two feature extractors is performed. The data expansion unit 112, the first processing unit 113, the second processing unit 114, and the update unit 115 optimize at least one of the two feature extractors (the first feature extractor and the second feature extractor) by executing, for all the conversion images, contrastive learning using two conversion images generated based on a conversion image. In other words, at least one of the first feature extractor and the second feature extractor is used as a training target, and is output as a trained machine learning model in a case where training is completed.

The first feature extractor and the second feature extractor receive an input of an image and output a feature vector as a feature amount of the image. As the first feature extractor and the second feature extractor, for example, a general neural network used for representation learning can be used. In addition, the parameter of the first feature extractor and the parameter of the second feature extractor may be the same or different.

The data expansion unit 112 generates, by using each conversion image, two conversion images used for contrastive learning. At this time, the data expansion unit 112 generates the conversion images using a conversion method different from the conversion method by the conversion unit 111. Hereinafter, the two generated conversion images are referred to as a first extended image and a second extended image. In representation learning such as contrastive learning, a conversion method in which a local structure is changed is used in a case where a plurality of conversion images is generated based on an image. The data expansion unit 112 performs conversion by randomly combining, for example, processing in color conversion, rigid transformation, filtering, masking, and image clipping.

The first processing unit 113 calculates, based on the first extended image, a first feature amount that is a feature amount of the first extended image. At this time, the first processing unit 113 inputs the first extended image to the first feature extractor. The first feature extractor receives an input of the first extended image, calculates a first feature amount from the first extended image based on one or more parameters, and outputs the calculated first feature amount.

The second processing unit 114 calculates, based on the second extended image, a second feature amount that is a feature amount of the second extended image. At this time, the second processing unit 114 inputs the second extended image to the second feature extractor. The second feature extractor receives an input of the second extended image, calculates a second feature amount from the second extended image based on one or more parameters, and outputs the calculated second feature amount.

The update unit 115 updates the parameter of at least one of the first feature extractor and the second feature extractor based on the first feature amount and the second feature amount. For example, the update unit 115 optimizes the feature extractor to be trained by updating the parameter of at least one of the first feature extractor and the second feature extractor such that two feature amounts (first feature amount and second feature amount) calculated based on the same conversion image approach each other.

The data expansion unit 112, the first processing unit 113, the second processing unit 114, and the update unit 115 execute representation learning using all the conversion images, and then output at least one of the optimized first feature extractor and second feature extractor as a trained neural network. The trained neural network is output to a device that executes an image-target task, as a neural network that receives an input of an image and outputs a feature amount of the image.

Note that both the first feature extractor and the second feature extractor may be set as training targets, and the neural network including both the feature extractors may be output as a trained neural network.

### (Pre-Training Processing)

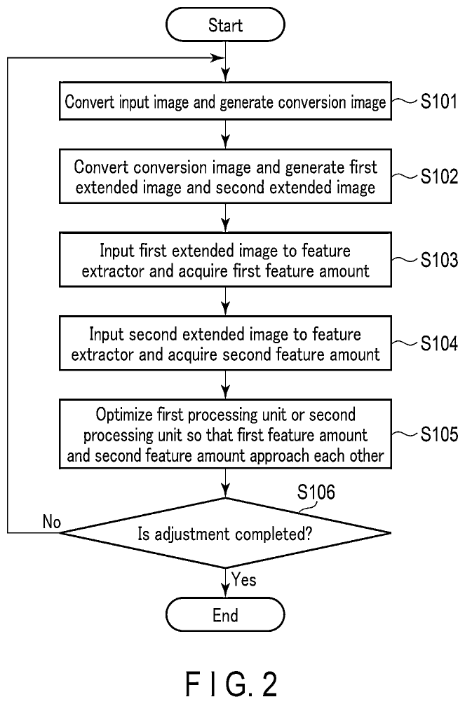

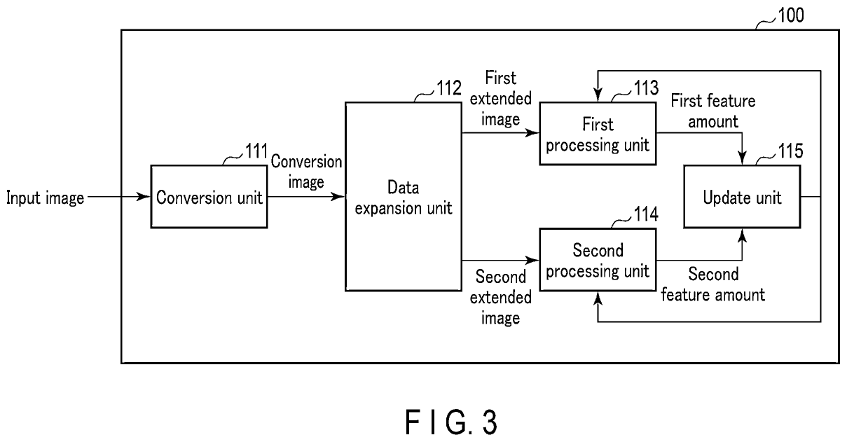

Next, an operation of the pre-training processing executed by the pre-training apparatus 100 will be described. The pre-training apparatus 100 starts pre-training processing based on acquisition of a small number of input images as labeled training data. FIG. 2 is a flowchart illustrating an example of a procedure of the pre-training processing. FIG. 3 is a diagram illustrating an example of a flow of data in the pre-training processing. Here, a case will be described, as an example, in which the first feature extractor is set as a training target. Note that the processing procedure in each processing described below is merely an example, and each processing can be appropriately changed as much as possible. In addition, with respect to the processing procedure described below, it is possible to appropriately omit, replace, and add steps according to the embodiment.

### (Step S101)

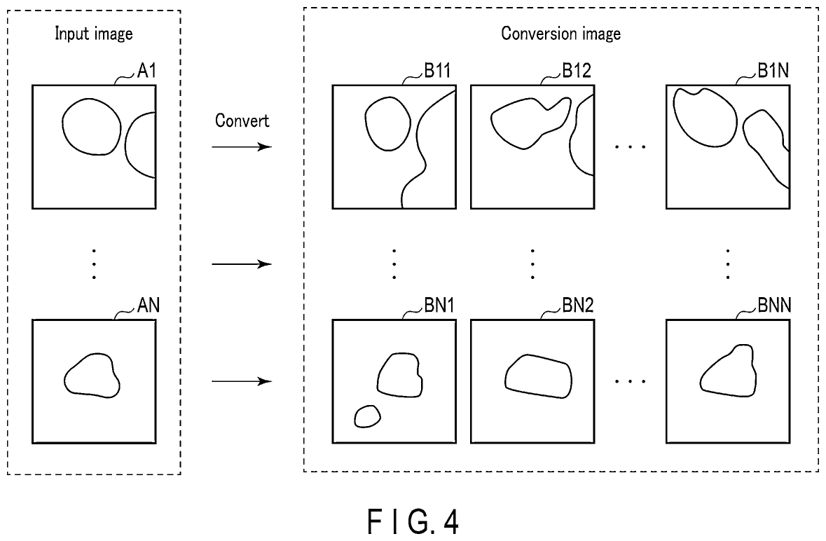

In the pre-training processing, first, the conversion unit 111 converts an input image to generate a conversion image. FIG. 4 is a diagram illustrating a flow of processing of converting an input image. The conversion unit 111 converts an input image in a process, and generates a plurality of conversion images in which the local structure is maintained and the global structure is deformed. For example, the conversion unit 111 generates N conversion images B11 to B1N from an input image A1. In a case where the input image is transformed, the method of perturbing and replacing partial images described above, the method using the affine transformation, the method of rearranging partial images, and the like can be used.

### (Step S102)

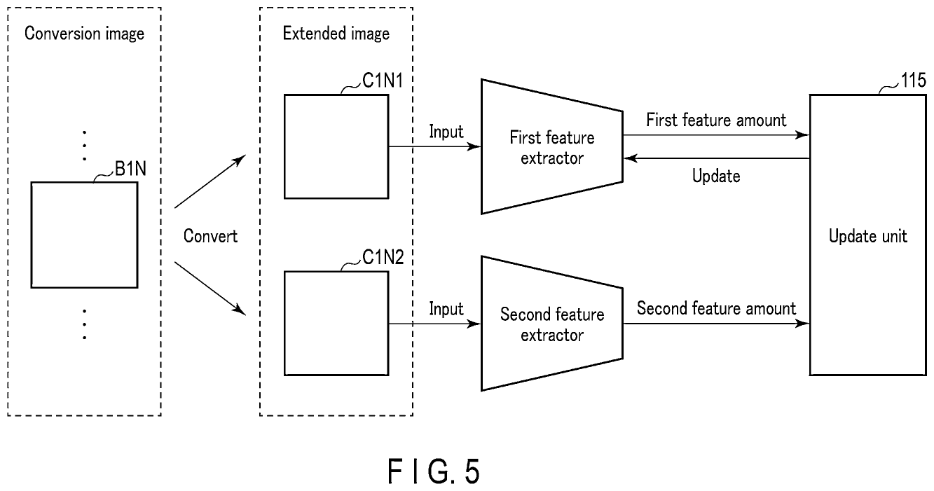

Next, the data expansion unit 112 converts the conversion image to generate a first extended image and a second extended image. FIG. 5 is a diagram illustrating a flow of processing regarding representation learning after step S102. The conversion unit 111 generates the first extended image and the second extended image one by one for each conversion image generated by the processing in step S101. For example, the conversion unit 111 generates first extended images C111 to C1N1 and second extended images C112 to C1N2 from conversion images B11 to B1N. In generating the first extended images and the second extended images, for example, a method combining color conversion, rigid transformation, filtering, masking, image clipping, and the like can be used.

### (Step S103)

Next, the first processing unit 113 inputs the first extended image to the first feature extractor, and acquires, as the first feature amount, a feature vector output from the first feature extractor.

### (Step S104)

Similarly, the second processing unit 114 inputs the second extended image to the second feature extractor, and acquires, as the second feature amount, a feature vector output from the second feature extractor.

### (Step S105)

Next, the update unit 115 adjusts and updates the parameter of the first feature extractor such that the first feature amount and the second feature amount approach each other.

### (Step S106)

Next, the update unit 115 determines whether to end adjustment of the parameter of the first feature extractor. In a case where it is determined not to end the adjustment of the feature extractor (No in step S106), the process returns to step S101. Thereafter, the processing of steps S101 to S105 is repeated for the input image not yet used for training, and the first feature extractor is adjusted using all the input images.

In a case where the adjustment of the first feature extractor is completed for all the input images (Yes in step S106), the pre-training apparatus 100 ends the pre-training processing, and outputs, as a trained neural network, the first feature extractor whose parameter has been adjusted to an external device or the like.

In the processing of step S105, the second feature extractor may be optimized instead of the first feature extractor, or both the first feature extractor and the second feature extractor may be optimized.

Hereinafter, effects of the pre-training apparatus 100 according to the present embodiment will be described.

The pre-training apparatus 100 according to the present embodiment includes the conversion unit 111, the data expansion unit 112, the first processing unit 113, the second processing unit 114, and the update unit 115. The conversion unit 111 converts the input image to generate a conversion image. At this time, the conversion unit 111 generates, as the conversion image, an image in which the local structure of the input image is maintained and the global structure of the input image is deformed. As a method for generating the conversion image, for example, a method of perturbing and replacing partial images, a method using the affine transformation, a method of rearranging partial images, and the like can be used.

The data expansion unit 112 generates the first extended image and the second extended image from the conversion image based on a method different from the method for generating the conversion image. For example, the data expansion unit 112 generates the first extended image and the second extended image by executing one or more processing of color conversion, rigid transformation, filtering, image masking, and image clipping. The first processing unit 113 inputs the first extended image to the first feature extractor to calculate the first feature amount, and the second processing unit 114 inputs the second extended image to the second feature extractor to calculate the second feature amount. The update unit 115 updates a parameter of at least one of the first feature extractor and the second feature extractor based on the first feature amount and the second feature amount. At this time, the update unit 115 updates the parameter of at least one of the first feature extractor and the second feature extractor so that the first feature amount and the second feature amount output based on the same conversion image approach each other.

With the above configuration, the pre-training apparatus 100 according to the present embodiment can prepare a large amount of unlabeled data necessary for pre-training by converting labeled data by a method different from the conversion method at the time of representation learning even in a case where only a small amount of labeled data is available at the time of performing pre-training of a neural network that executes an image-target task by representation learning. This enables highly accurate pre-training.

Furthermore, the pre-training apparatus 100 according to the present embodiment can convert the training data in which the local structure is maintained by converting the input image using the method in which the local structure of the input image is maintained and the global structure of the input image is deformed. An image whose local structure has not changed can be used as training data for training the feature of the target image regardless of the type of the task. For example, even if an image that does not actually exist is generated as a conversion image, the image can be used as unlabeled data because a local structure contributing to a task for the image is maintained. As described above, by performing the data extension using the conversion method in which the local structure is maintained, a large amount of unlabeled data can be prepared without designing or selecting the data extension according to the type of the task. Therefore, even in a case where there is little training data, the training data that can be used for the pre-training can be increased, and the accuracy of the pre-training can be improved.

In addition, by training the neural network using the above pre-training method, it is possible to generate a trained neural network capable of executing an image-target task with high accuracy.

### Second Embodiment

A second embodiment will be described. The present embodiment is obtained by modifying the configuration of the first embodiment as follows. Description for the configurations, operations, and effects similar to those of the first embodiment will be omitted. According to the present embodiment, representation learning is performed by excluding a conversion image that is not suitable as training data for pre-training.

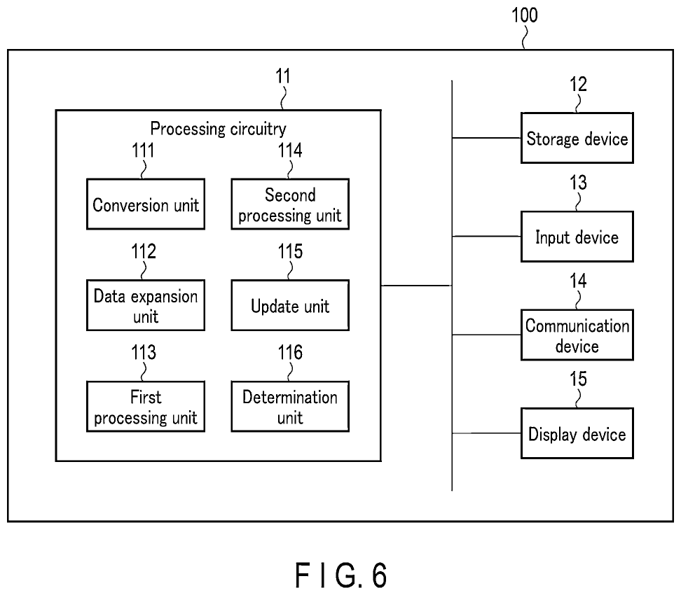

FIG. 6 is a diagram illustrating a configuration example of a pre-training apparatus 100 according to the present embodiment. As illustrated in FIG. 6, the processing circuitry 11 further includes a determination unit 116. The processing circuitry 11 further realizes the determination function by executing the pre-training program.

The determination unit 116 selects a conversion image suitable for training by determining whether to use the generated conversion image for training. For example, the determination unit 116 determines whether to use each conversion image for training based on an error between the conversion image and the input image, an attribute between the conversion image and the input image, or a statistical value of the conversion image. According to the present embodiment, the determination unit 116 calculates an error between the input image and the conversion image, determines that the conversion image having a large error is not suitable for training, and selects the conversion image having a small error as an image suitable for training.

### (Pre-Training Processing)

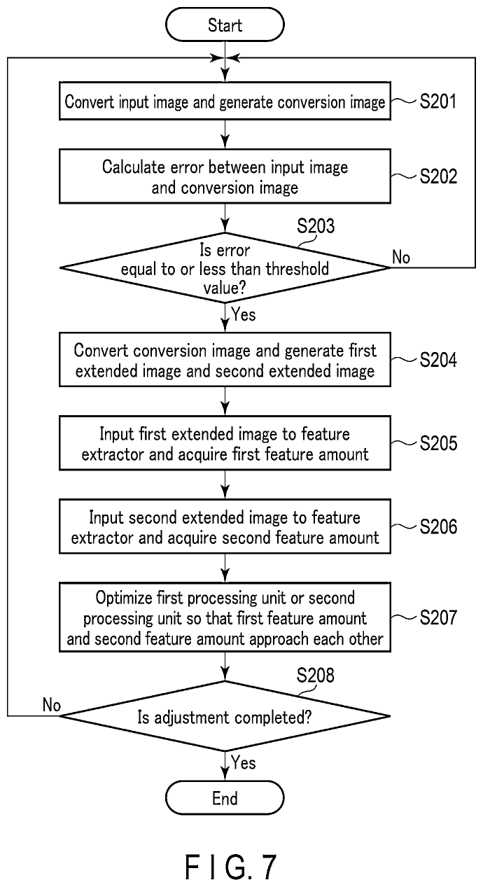

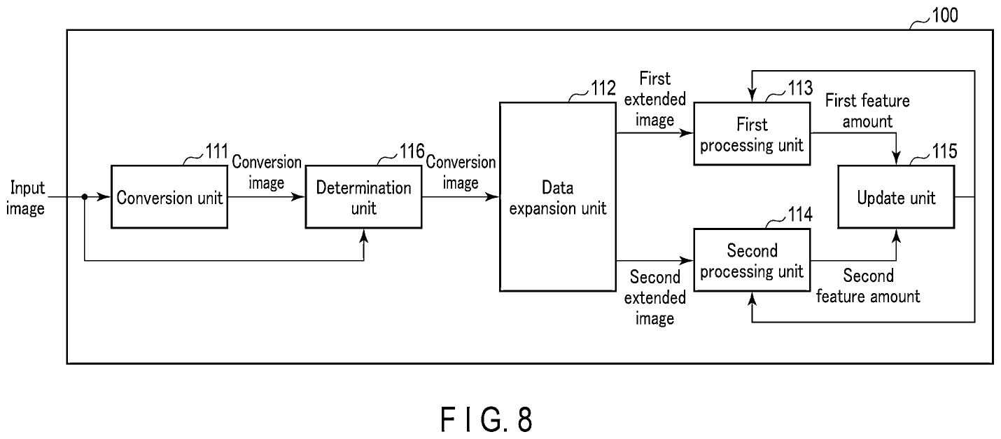

Next, an operation of the pre-training processing executed by the pre-training apparatus 100 according to the present embodiment will be described. FIG. 7 is a flowchart illustrating an example of a procedure of pre-training processing. FIG. 8 is a diagram illustrating an example of a flow of data in the pre-training processing. Since the processing in steps S201 and S204 to S208 in FIG. 7 is similar to the processing in steps S101 and S102 to S106 in FIG. 2, detailed description thereof will be omitted.

### (Step S202)

In a case where the conversion image is generated based on an input image in the processing of step S201, the determination unit 116 calculates an error between the generated conversion image and the original input image. As the error, for example, a mean squared error (MSE) or a mean absolute error (MAE) can be used. Alternatively, a difference between statistical values or a difference between feature amounts calculated using a feature extractor may be used as the error. As the statistical value, for example, an average value, a variance, a standard deviation, a median value, a mode value, or the like of each pixel value can be used. The error may be referred to as a difference value.

### (Step S203)

Next, the determination unit 116 determines whether to use the conversion image for subsequent training processing based on an error from the original input image. At this time, the determination unit 116 determines whether an error between the target conversion image and the input image is equal to or less than a threshold value.

In a case where the error from the original input image is equal to or less than the threshold value (Yes in step S203), the determination unit 116 determines that the conversion image is suitable for training, and proceeds to steps S204 to S207 to execute contrastive learning using the conversion image. On the other hand, in a case where the error from the original input image is greater than the threshold value (No in step S203), the determination unit 116 determines that the conversion image is not suitable for training because the conversion image is too different from the original input image. In this case, the contrastive learning using the conversion image is not executed, and the processing returns to step S201 to generate a conversion image of a next input image.

Note that a conversion image having an excessively small error from the input image may also be determined as an image unsuitable for training. In this case, the determination unit 116 determines a conversion image having an error within a predetermined range from the original input image as an image suitable for training.

Furthermore, in a case where a plurality of conversion images is generated for an input image, the processing of steps S202 to S207 is repeatedly executed for each conversion image generated from the same input image.

The pre-training apparatus 100 repeatedly executes the processing of steps S201 to S207 until the adjustment of the parameter by the contrastive learning using all the input images is completed (No in step S208), and executes the contrastive learning using only the conversion image determined to be suitable for training. In a case where the processing of steps S201 to S207 for all the input images is completed (Yes in step S208), the pre-training apparatus 100 determines that the adjustment of the parameters is completed, and ends the pre-training processing.

The pre-training apparatus 100 according to the present embodiment further includes the determination unit 116 that determines whether to use the conversion image for training, and the determination unit 116 can calculate an error between the input image and the conversion image and determine whether to use the conversion image for training based on the error. With the above configuration, the accuracy of pre-training is further improved by selecting conversion images suitable for training based on an error from the input image and performing pre-training using only the selected conversion images. For example, the learning accuracy can be improved by excluding the conversion image having a too large difference from the input image and performing pre-training.

### First Modification

A comparison result of the attributes of the input image and the conversion image may be used instead of the error between the input image and the conversion image. In this case, the determination unit 116 estimates the attributes of the input image and the conversion image, and determines whether the estimated attributes match, thereby determining whether to use the conversion image.

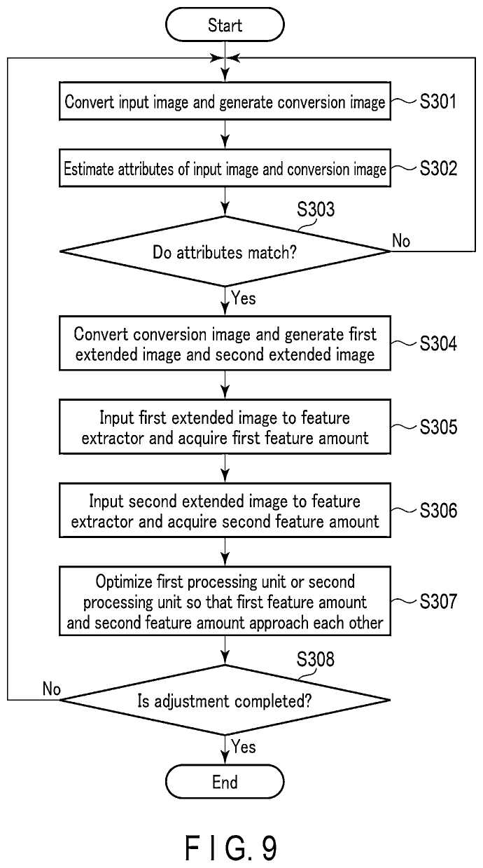

FIG. 9 is a flowchart illustrating an example of a procedure of pre-training processing according to the present modification. The processing in steps S301 and S304 to S308 in FIG. 9 is similar to the processing in steps S201 and S204 to S208 in FIG. 7, and thus detailed description thereof is omitted.

### (Step S302)

According to the present modification, the determination unit 116 estimates an attribute for each of the input image and the conversion image. As the attribute, for example, a label such as class information or type information used in the downstream task can be used. In this case, the determination unit 116 estimates the label of the conversion image using a prescribed feature extractor that estimates the label. At this time, a label preset in the input image may be used as an attribute of the input image. In addition, cluster information such as a classification result by unsupervised classification processing may be used as the attribute. In this case, the determination unit 116 performs unsupervised classification processing on each of the input image and the conversion image.

### (Step S303)

Next, the determination unit 116 compares the attribute of the original input image with the attribute of the conversion image, and determines whether to use the conversion image for subsequent training processing. At this time, the determination unit 116 determines whether the attributes of the conversion image match the attributes of the input image.

In a case where the attributes of the conversion image and the original input image match (Yes in step S303), the determination unit 116 determines that the conversion image is suitable for training, proceeds to steps S304 to S307, and executes contrastive learning using the conversion image. On the other hand, in a case where the attribute of the conversion image does not match that of the original input image (No in step S303), the determination unit 116 determines that the conversion image is not suitable for training because the conversion image is too different from the original input image. In this case, the contrastive learning using the conversion image is not executed, and the processing returns to step S301 to generate a conversion image of a next input image.

Also in the present modification, by selecting a conversion image suitable for training and performing training using only the selected conversion image, the accuracy of pre-training can be further improved.

### Second Modification

A conversion image suitable for training may be selected using the statistical value of the conversion image. In this case, the determination unit 116 uses a statistical value of the pixel values of the conversion image to determine whether to use the conversion image for representation learning. As the statistical value, for example, an average value, a variance, a standard deviation, a median value, a mode value, or the like of each pixel value can be used. The determination unit 116 calculates a statistical value of the conversion image and determines whether the statistical value satisfies a predetermined condition, thereby selecting a conversion image suitable for training. Then, by executing training with only the selected conversion images, the accuracy of pre-training can be further improved. For example, the determination unit 116 selects a conversion image in which an error between the statistical value of the input image and the statistical value of the conversion image is equal to or less than a threshold value as the conversion image suitable for training.

In this manner, any one of the above-described embodiments can provide a pre-training apparatus, a pre-training method, and a pre-training program capable of improving the accuracy of pre-training regardless of the type of the task.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pre-training apparatus comprising
processing circuitry that is configured to:
convert an input image to generate a conversion image;
generate a first extended image and a second extended image from the conversion image based on a method different from a method for generating the conversion image;
input the first extended image to a first feature extractor to calculate a first feature amount;
input the second extended image to a second feature extractor to calculate a second feature amount; and
update a parameter of at least one of the first feature extractor and the second feature extractor based on the first feature amount and the second feature amount.

2. The pre-training apparatus according to claim 1, wherein
the processing circuitry generates, as the conversion image, an image in which a local structure of the input image is maintained and a global structure of the input image is deformed.

3. The pre-training apparatus according to claim 2, wherein
the processing circuitry converts the input image into two or more image having different resolutions, generates perturbation partial images in which a perturbation is added to partial images cut out from the two or more image having different resolutions, generates a partial image after addition by weighted addition of the perturbation partial images having different resolutions, and generates the conversion image by replacing a partial image at a position corresponding to the partial image after the addition of the input image with the partial image after the addition.

4. The pre-training apparatus according to claim 2, wherein
the processing circuitry generates the conversion image by performing affine transformation on the input image.

5. The pre-training apparatus according to claim 2, wherein
the processing circuitry generates the conversion image by performing conversion based on an adjusted parameter on the input image.

6. The pre-training apparatus according to claim 1, wherein
the processing circuitry generates the first extended image and the second extended image by executing one or more processes of color conversion, rigid transformation, filtering, image masking, and image clipping.

7. The pre-training apparatus according to claim 1, wherein
the processing circuitry determines whether to use the conversion image for training.

8. The pre-training apparatus according to claim 7, wherein
the processing circuitry calculates an error between the input image and the conversion image, and determines whether to use the conversion image for training based on the error.

9. The pre-training apparatus according to claim 7, wherein
the processing circuitry estimates attributes of the input image and the conversion image, and determines whether to use the conversion image by determining whether the attributes match.

10. The pre-training apparatus according to claim 7, wherein
the processing circuitry determines whether to use the conversion image for training based on a statistical value of the conversion image.

11. The pre-training apparatus according to claim 1, wherein
the pre-training apparatus is a training device that trains a neural network including at least one of the first feature extractor and the second feature extractor.

12. The pre-training apparatus according to claim 2, wherein
the processing circuitry generates, as the first extended image and the second extended image, an image in which a local structure of the conversion image has changed.

13. A method comprising:
converting an input image to generate a conversion image;
generating a first extended image and a second extended image based on a method different from a method for generating the conversion image;
inputting the first extended image to a first feature extractor to calculate a first feature amount;
inputting the second extended image to a second feature extractor to calculate a second feature amount; and
updating a parameter of at least one of the first feature extractor and the second feature extractor based on the first feature amount and the second feature amount.

14. A non-transitory computer-readable storage medium storing a program for causing a computer to execute:
converting an input image to generate a conversion image;
generating a first extended image and a second extended image based on a method different from a method for generating the conversion image;
inputting the first extended image to a first feature extractor to calculate a first feature amount;
inputting the second extended image to a second feature extractor to calculate a second feature amount; and
updating a parameter of at least one of the first feature extractor and the second feature extractor based on the first feature amount and the second feature amount.
